(19) United States
(12) Patent Application Publication
(10) Pub. No.: US 2008/0155574 A1
(43) Pub. Date: Jun. 26, 2008

(54) Meta-data driven data access system

(76) Inventors: Nilesh R. Gohel, Fremont, CA (US); Andrew A. Feng, Cupertino, CA (US); Kenneth R. Thomas, Santa Clara, CA (US); Yang Li, Milpitas, CA (US); Charles Bracher, Santa Cruz, CA (US)

Correspondence Address: BRINKS HOFER GILSON & LIONE / YAHOO! OVERTURE, P.O. BOX 10395, CHICAGO, IL, 60610, US

(21) Appl. No.: 11/642,576

(22) Filed: Dec. 20, 2006

(51) Int. Cl. G06F 9/44

(52) U.S. Cl. 719/328

(57) ABSTRACT

A meta-data driven data access system provides a calling application access to a plurality of data sources. The system includes a client API and a broker server. The client API receives a request for attribute data from the calling application. The client API accesses attribute structures in a local meta-data bank corresponding to the requested attribute data. The client API retrieves the attribute data from local adapters where available. If the attribute structure is not contained within the local meta-data bank, the client API requests the attribute data from the broker server. The broker server also includes a local meta-data bank and local source adapters. Accordingly, the broker server accesses the local meta-data bank to identify the adapters associated with each requested piece of attribute data. The broker server then retrieves the attribute data from the adapters associated with each attribute structure.

### BACKGROUND

With the expansion of the internet in recent years, more and more sources of data have become available to users. These sources of data are often compiled and maintained by different entities. Therefore, the data sources may have different storage formats, as well as, different interfaces that are defined to access the data. For these reasons, enterprise systems have been limited with respect to the data that is available for access. Typically, each enterprise solution would expect a unique data structure for processing or display. Conversion programs, typically called interface modules, need to be written to allow interfacing to each individual data source. Further, these conversion programs may be specific to each application. Over time, many enterprise systems developed interface modules to popular data sources either due to consumer demand or due to strategic alliances between companies. For example, a corporation may acquire multiple technology companies and operate the companies as complimentary business units. Many data sources have different data elements for common entities such as customers, users, or products. Therefore, accessing all of the available data on an entity may be difficult when the data is spread out across a number of data sources. Providing a unified view of data elements from a variety of data sources may be useful for many applications.

However, each application may have different requirements. For some applications data access may be very time sensitive and the need to retrieve data immediately is a primary concern. Other applications may place a higher value on lower overhead operations, for example less software to install and maintain, as well as, less connection management. New data from existing data sources should be made available to the consumer or application transparently without the installation of new software. Further, the system should accommodate a variety of application requirements. For example, online web searches require frequent access to some data elements, while access to other data elements may be very infrequent. It is also important for consumers and application developers to have knowledge of all the data elements available that are associated with a particular entity.

In view of the above, it is apparent that there exists a need for an improved data access scheme for online systems.

### SUMMARY

In satisfying the above need, as well as overcoming the enumerated drawbacks and other limitations of the related art, the present invention provides a meta-data driven data access system.

The system provides access to a plurality of data sources from a calling application. The system includes a client application programming interface (“API”) and a broker server. The client API receives a request for attributes from the calling application over an application interface. The client API includes a meta-data bank, a data source adapter, and a broker source adapter. The meta-data bank includes a list of attribute structures where each attribute structure is associated with an adapter by the meta-data bank. Accordingly, the client API accesses the attribute structures in the meta-data bank corresponding to the requested attribute data and retrieves attribute data through the associated adapter. As such, the client API retrieves attribute data from the data source adapter installed with the client API. If the attribute structure is not contained within the meta-data bank of the client API, the client API requests the attribute structure from the broker server through the broker source adapter.

The broker server also includes a meta-data bank and source adapters. Accordingly, the broker server accesses the meta-data bank on the broker server to identify the adapters associated with each attribute structure. The broker server then retrieves attribute data from the adapters associated with each attribute structure. Both the client API and the broker server may develop execution plans identifying the order that the attribute data will be retrieved. The execution plan is particularly helpful with regard to compute adapters or format adapters that generate attribute data based on other attribute data. In addition, the client API and broker server may store the execution plan to enhance the efficiency when retrieving data for frequently requested groups of attribute data.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a data access system in accordance with one embodiment;

FIG. 2 is a chart illustrating one embodiment of a meta-data model; and

FIG. 3 is a flow chart of a method for processing data in accordance with one embodiment.

### DETAILED DESCRIPTION

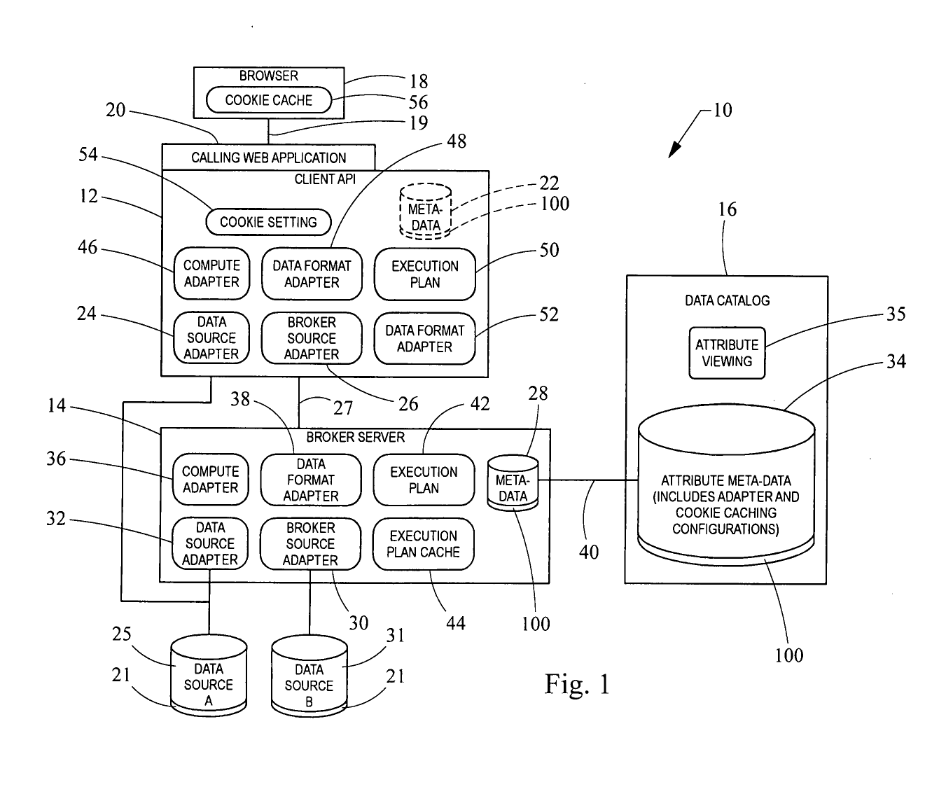

Referring now to FIG. 1, a system for accessing data according to one embodiment is illustrated therein and designated at 10. The system 10 includes a client API 12, a broker server 14, and a data catalog 16. The following description will discuss a web-based calling application 20 accessed through a browser 18. However, it is understood that various calling applications may be utilized either locally on the same system or in a distributed architecture located on multiple servers.

A user interacts with a browser 18, for example on a personal computer. The browser 18 produces an HTTP request that may be communicated, for example over the internet, to the calling application 20 as denoted by line 19. The calling application 20 may perform various functions to generate a display for the browser 18 including, for example, generating and formatting content by accessing data, performing calculations on data, or other processing. As mentioned above, the calling application 20 may be an enterprise solution and, therefore, may be enhanced by accessing a wide variety of data sources. Typically, each data source would require a separate data interface to be written specifically to access each individual data source. However, the client API 12 interfaces with the calling application 20 and provides access to a wide variety of data sources through a single interface.

The client API 12 includes a meta-data bank 22, a source adapter 24, and a broker source adapter 26. The meta-data bank 22 stores attribute structures, described in more detail below, local to the client API 12. The meta-data bank 22 includes a listing of attribute structures, each attribute structure 100 corresponding to attribute data 21 that may be requested by the calling application 20. The client API 12 searches the meta-data bank 22 to determine if each corresponding attribute structure 100 is available locally. If each of the attribute structure 100 is available locally, the client API 12 will determine if a local data source adapter, such as data source adapter 24, can provide access to the appropriate data source, such as data source 25. Alternatively, the client API 12 may request the attribute data 21 from the broker server 14. The client API 12 is scalable in that one or many adapters may be installed in the client API 12 for local access. However, whether the client API 12 utilizes a local adapter or the broker server 14 to retrieve the attribute data 21 will be transparent to the calling application 20 and inherently processed by the client API 12.

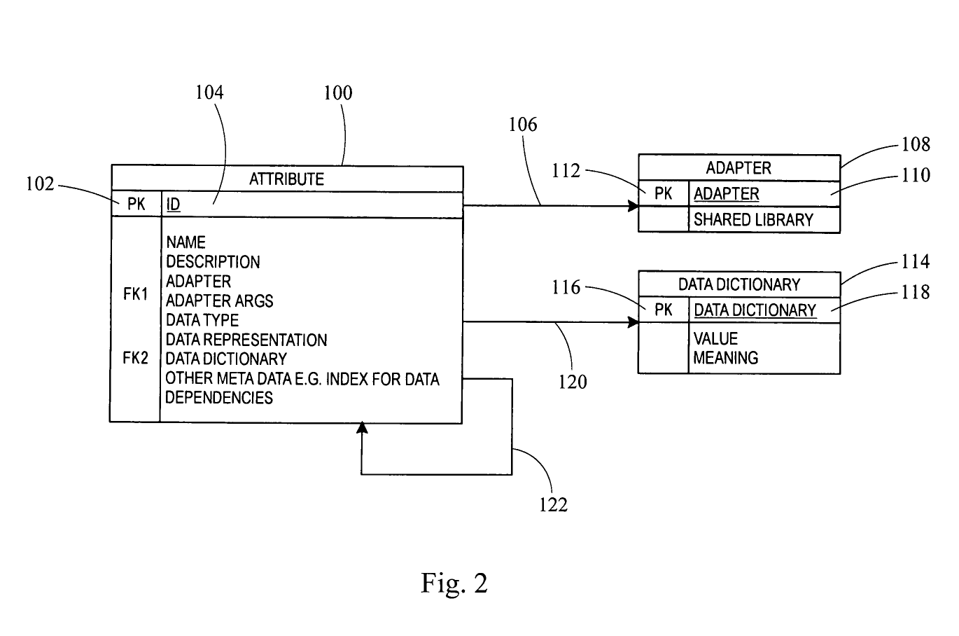

Referring now to FIG. 2, an exemplary attribute structure 100 is provided. Each attribute structure 100 comprises a list of IDs 104 that are each associated with a data element or a key for a data structure, as denoted by the key list 102. The list of IDs 104 may include a name, a description, an adapter, adapter arguments, a data type, a data representation, a data dictionary, or other meta-data, for example data dependencies. The name ID is an attribute identifier, such as zip code. The description ID may include additional information, for example how the attribute data 21 is to be used or how the attribute data 21 is derived. The attribute description may be made available to developers of various calling applications allowing them to effectively utilize the attribute. The adapter ID may include a reference to a data source adapter 24, a compute adapter 46, or a data format adapter 48. Further, the adapter ID may be a foreign key as denoted in the key list 102. As such, the adapter 108 may comprise an adapter data structure accessible from the attribute structure 100 as denoted by line 106. The adapter 108 may include a set of adapters 110 that allow access to a data source for a data element corresponding to the attribute structure 100. As denoted by reference numeral 112, the adapters are software components that may be fashioned as a shared library (.so) components listed as 110 for loading by the client or broker server.

Referring again to the ID list 104, the adapter arguments ID may be used to define variables or provide configuration information needed by the adapter to access the appropriate data source. In addition, it is noted that the same set of adapters may be re-used across multiple attributes, for example, by changing the adapter arguments for each attribute. Similarly, the data type and data representation may be used in defining and formatting the piece of data that is retrieved from the data source through the data source adapter or compute adapter.

For example, the data type may typically include integers, strings, list of integers, floats, Booleans, etc. Further, the data representation may further define the data format which may include day-month-year, month-day-year, AM/PM, 24 hour, etc. Similar to the adapter 108, the data dictionary 114 may include a foreign key to a data dictionary structure, as denoted by line 120. The data dictionary 114 may include a list 118 of the potential data values returned for an attribute, as well as, a corresponding descriptive meaning of the values. In one example, a tenure attribute may have a value of 1 that indicates 1-7 years, where a value of 2 indicates 8-15 years, and so on. As noted by column 116, a foreign key may be used to further define the structure of a data dictionary attribute in the data dictionary attribute list 118.

The attribute ID list 104 may also include dependencies of the attribute structure 100 on other attribute structures in the meta-data bank 22. These dependencies are often used by compute adapters, such as compute adapter 46 (in FIG. 1). Compute adapters calculate attribute data based on one or more inputs. Accordingly, one or more other pieces of attribute data may need to be retrieved prior to processing the attribute structure 100 in a compute adapter 46. The dependencies of an attribute structure may be used to define the order in which pieces of attribute data are retrieved from the data source adapter 24 or calculated by the compute adapter 46.

Referring again to FIG. 1, an execution plan 50 may be developed by the client API 12. The execution plan 50 may require that all of the pieces of attribute data are retrieved from the local data source adapter 24 or the broker server 16 prior to calculating any attribute data using the compute adapter 46 helping to ensure each attribute dependency is updated prior to the calculation. If the attribute structure 100 is not available in the local meta-data bank 22, the client API 12 will utilize a broker source adapter 26 to connect with the broker server 14, as denoted by line 27. The connection between the client API 12 and the broker server 14 may be a simple software interface, if both applications are running on the same hardware. However, in a more common embodiment, client API 12 is connected to the broker server 14 over an internal network, for example a local area network such as an Ethernet network. The broker server 14 includes a local meta-data source 28, as well as, a first and second data source adapter 30, 32. The broker source adapter 26 requests attribute data 21 from the broker server 14. The broker server 14 searches the local meta-data bank 28 for each attribute structure 100 corresponding to the requested attribute data 21. If each corresponding attribute structure 100 is found in the local meta-data bank 28, the broker server 14 checks if the associated adapters are installed on the broker server 14. For example, if the attribute data 21 is available in data source 31, the attribute structure 100 would identify data source adapter 30. Accordingly, data source adapter 30 would receive the appropriate arguments associated with the attribute structure 100 and retrieve attribute data 21 from the data source 31. Alternatively, if the attribute structure 100 corresponded to attribute data 21 in data source 25, the broker server 14 would utilize data source adapter 32 to retrieve the attribute data 21 in data source 25.

However, if the requested attribute structure 100 is not available in the local meta-data bank 28, the broker server 14 may access a data catalog 16 that serves as a global repository for all attribute structures, as shown by meta-data bank 34. As previously discussed, application designers may be provided access to attribute information for all of the attribute structures in the meta-data bank 34 through an attribute viewer 35. The broker server 14 may communicate with the data catalog 16 through a software interface that may take one of many forms. For example, a distributed architecture interface between the broker server 14 and the data catalog 16 may be implemented over a local area network 40, such as Ethernet.

From time to time, attribute structures stored in the data catalog 16 will need to be updated. The data catalog 16 is configured to automatically update local meta-data banks 22, 28 of the broker server 14 or client API 12 according to meta-data bank 34. If the attribute structure is not available locally through the meta-data bank 28 or the data catalog 16, it is understood that another broker server may be accessed through another broker source adapter (not shown), or an attribute error may be generated and provided back to the client API 12. Similarly, if the attribute structure is available, however, the associated data source adapter, compute adapter, or data format adapter is not available, then an adapter error may be returned to the client API 12 by the broker server 14.

Once the adapter and dependencies for each attribute structure 100 have been retrieved from the meta-data bank 28, the broker server 14 may generate an execution plan 42 that defines the order in which the attribute data 21 is retrieved from the data source adapter 30, 32, calculated by the compute adapter 36, and/or formatted by the data format adapter 38. In addition, for frequently requested groups of attribute data the execution plan 42 may be saved in an execution plan cache 44 to enhance the efficiency of retrieving the attribute structures. The execution plan 42 is then executed and each attribute structure is processed by the broker server 14 according to the execution plan 42. It is well understood that the execution plan 42 may process each attribute structure sequentially, or alternatively may process certain attribute structures in parallel where appropriate based on attribute dependencies. In addition, any execution plans stored in execution plan cache 44 are automatically updated or erased when any of the meta-data banks 28, 34 are updated. When all of the attribute data requested by the client API 12 has been retrieved by the broker server 14, the results are returned to the client API 12.

Similar to the broker server 14, the client API 12 develops an execution plan 50 based on the attribute data requested from the calling application 20. If some of the attribute structures are available in the local meta-data bank 22 and the attribute data is available through local data source adapters, such as data source adapter 24, then portions of the execution plan 50 may be processed in parallel with the request to the broker server 14 for additional attribute data, as long as, no attribute dependencies prevent further execution. In addition, compute adapters, such as compute adapter 46, and data format adapters, such as data format adapter 48, may be processed later in the execution plan 50 based on attribute dependencies. Similar to the broker server 14, compute adapter 46 may calculate attribute data based on one or more inputs where the inputs may be other retrieved or calculated attribute data. The data format adapter 48 may format the data based on retrieved attribute data, for example, retrieving a date in European format (day/month/year) and formatting it in US format (month/day/year) prior to providing it to the calling application 20.

Similar to the broker server 14, the client API 12 may also save frequently used execution plans 50 in an execution plan cache 52. In addition, any execution plans stored in execution plan cache 52 are automatically updated or erased when any of the meta-data banks 22, 28, or 34 are updated. Further, the client API 12 may include cookie settings 54 that are provided to the calling application 20. The cookie settings 54 may be provided to the calling application 20 such that the attribute data, the execution plan, or both may be stored as a cookie 56 by the browser 18 on a user PC. The meta-data for an attribute may be used to determine if the attribute data should be cached in the cookie 56, as well as, determining how long the data should be valid for once cached.

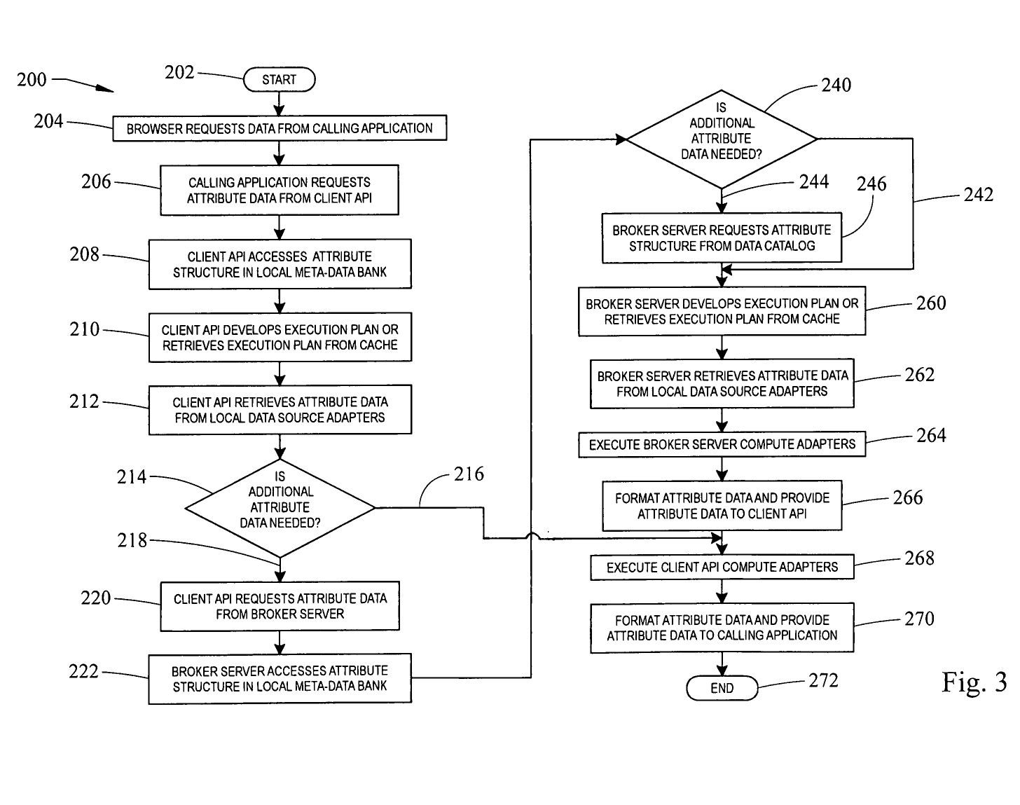

Now referring to FIG. 3, a method 200 for meta-data driven data access begins in block 202. In block 204, a browser requests data from the calling application 20, for example through an HTTP request. The calling application 20 generates content in response to the HTTP request and further requests attribute data from the client API 12 as denoted by block 206. In block 208, a client API 12 accesses corresponding attribute structures in a local meta-data bank 22. In block 210, the client API 12 generates an execution plan 50 or retrieves an execution plan 50 from cache 52, if the execution plan 50 already exists. In block 212, the client API 12 retrieves attribute data from the local data source adapters 24 for attribute structures that are associated with data source adapter 24 and where the attribute structure does not depend on other attribute data that cannot be accessed locally through data source adapter 24. In block 214, the client API 12 determines if additional attribute data has been requested that does not have a corresponding attribute structure in the local meta-data bank 22 or is not available through local data source adapter 24. If additional attribute data is not requested, the method 200 follows line 216 to block 268. However, if additional attribute data is requested, the method 200 follows line 218 to block 220. In block 220, the client API 12 requests attribute data from the broker server 14. The broker server 14 accesses corresponding attribute structures in the local meta-data bank 28, as denoted by block 222. In block 240, the broker server 14 determines if additional attribute data is requested that does not have a corresponding attribute structure in the local meta-data bank 28. If additional attribute data is not requested, the method 200 follows line 242 to block 260. However, if additional attribute data is requested, the method 200 follows line 244 to block 246, where the broker server 14 requests corresponding attribute structures from the meta-data bank 34 in the data catalog 16. The data catalog 16 provides attribute structures to the broker server 14 and the method 200 proceeds to block 260. The broker server 14 then develops an execution plan 42 or retrieves an execution plan 42 from cache 44, as denoted by block 260. The broker server 14 receives attribute data from local data source adapters 30, 32, as denoted in block 262. The broker server 14 processes any compute adapters 36, as denoted in block 264. In block 266, the broker server processes any data format adapters 38 and provides the requested attribute data to the client API 12. In block 268, the client API 12 receives the attribute data from the broker server 14 and processes any compute adapters 46 according to the execution plan 50. In block 270, the client API 12 processes any data format adapters 48 and provides the requested attribute data to the calling application 20, as denoted by block 270. As previously discussed, the attribute data 21 can be stored as a cookie 56 through the calling application 20 and updated periodically. The end of the method 200 is denoted by block 272. It is understood that method 200 is exemplary and an alternative order of the steps, alternative processing conditions, and various error handling may be readily implemented within the scope of the present invention. Further, the method 200 may be embodied in a software program that is reduced to a set of instructions stored on a computer readable medium.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. A system for providing a calling application access to a plurality of data sources, the system comprising:
a client application program interface (“API”) in communication with the calling application to receive attribute data therefrom, the client API including a first meta-data bank, a first data source adapter, and a broker source adapter; and
a broker server in communication with the client API through the broker source adapter, the broker server including a second meta-data bank, and a second data source adapter.

2. The system according to claim 1, wherein the first and second meta-data bank includes a plurality of attribute structures, each attribute structure including an adapter structure identifying at least one adapter configured to access a data source of the plurality of data sources that includes attribute data.

3. The system according to claim 1, wherein the client API is configured to access the first meta-data bank and request attribute data through the first data source adapter.

4. The system according to claim 1, wherein the client API is configured to request the attribute data from the broker server if an attribute structure corresponding to the attribute data is not contained within the first meta-data bank.

5. The system according to claim 4, wherein the client API is configured to request attribute data from the broker server if a corresponding attribute structure is included in the first meta-data bank and an adapter structure of the corresponding attribute structure identifies a data source adapter not installed in the client API.

6. The system according to claim 4, wherein the broker server is configured to access the second meta-data bank and request the attribute data through the second data source adapter.

7. The system according to claim 6, wherein the broker server is in communication with a data catalog to access a third meta-data bank if the attribute structure is not contained in the second meta-data bank.

8. The system according to claim 7, wherein the data catalog includes an attribute viewer to provide access to attribute information.

9. The system according to claim 1, wherein the client API develops an execution plan based on an attribute structure corresponding to the attribute data requested by the calling application.

10. The system according to claim 9, wherein the execution plan is cached in the client API and accessed based on the requested attributes from the calling application.

11. The system according to claim 9, wherein the execution plan is provided to the calling application for storage as a cookie.

12. The system according to claim 9, wherein the client API includes a compute adapter, operative to calculate the attribute data based on at least one input, the compute adapter being associated with the attribute structure by the first meta-data bank.

13. The system according to claim 9, wherein the client API is configured to update the execution plan when the first meta-data bank is updated.

14. The system according to claim 1, wherein the broker server is configured to develop an execution plan based on attribute data requested by the client API.

15. The system according to claim 14, wherein the execution plan is cached in the broker server and accessed based on the attribute data requested by the client API.

16. The system according to claim 14, wherein the broker server includes a compute adapter and the compute adapter calculates the attribute data requested by the client API based on at least one input, the compute adapter being associated with an attribute structure by the second meta-data bank.

17. The system according to claim 1, wherein an update in a data catalog is configured to automatically update the first and second data bank.

18. The system according to claim 1, wherein the attribute data is provided to the calling application for storage as a cookie.

19. A method for providing a calling application access to a plurality of data sources, the method comprising:
requesting attribute data from a client API;
accessing a first meta-data bank in the client API;
determining if an attribute structure associated with the attribute data is contained in the first meta-data bank;
requesting the attribute data from a broker server;
accessing a second meta-data bank in the broker server;
determining if the attribute structure is contained in the second meta-data bank; and
requesting the attribute data through a data source adapter in the broker server.

20. (canceled)

21. The method according to claim 19, wherein requesting the attribute data from the broker server further comprises requesting the attribute data from the broker server if an attribute structure corresponding to the attribute data is not contained within the first meta-data bank and the requesting the attribute data from the broker server further comprises requesting the attribute data from the broker server if the attribute structure corresponding to the attribute data is included in the first meta-data bank and an adapter structure of the attribute structure is associated with an adapter not installed in the client API.

22. The method according to claim 19, wherein requesting the attribute data from the broker server further comprises requesting the attribute data from the broker server if an attribute structure corresponding to the attribute data is not contained within the first meta-data bank and, further comprising accessing a third meta-data bank in a data catalog if the attribute structure is not contained in the second meta-data bank.

23. (canceled)

24. The method according to claim 19, further comprising developing an execution plan based on the attribute data requested and caching the execution plan based on the attribute data requested.

25. (canceled)

26. In a computer readable storage medium having stored therein instructions executable by a programmed processor for providing a calling information access to a plurality of data sources, the storage medium comprising instructions for:
requesting attribute data from a client API;
accessing a first meta-data bank in the client API;
determining if an attribute structure associated with the attribute data is contained in the first meta-data bank;
requesting the attribute data from a broker server;
accessing a second meta-data bank in the broker server;
determining if the attribute structure is contained in the second meta-data bank; and
requesting the attribute data through a data source adapter in the broker server.

27. (canceled)

28. The instructions according to claim 26, further comprising instructions for requesting the attribute data from a broker server if the attribute structure corresponding to the attribute data is not contained within the first meta-data bank and requesting the attribute data from the broker server if the attribute structure corresponding to the attribute data is included in the first meta-data bank and an adapter structure of the attribute structure is associated with an adapter not installed in the client API.

29-30. (canceled)

31. The instructions according to claim 26, further comprising instructions for developing an execution plan based on the attribute data requested and caching the execution plan based on the attribute data requested.

32. (canceled)
